(19) United States
(12) Patent Application Publication
(10) Pub. No.: US 2016/0285094 A1
(43) Pub. Date: Sep. 29, 2016

(54) ELECTRODE FOR NONAQUEOUS ELECTROLYTE SECONDARY BATTERY, NONAQUEOUS ELECTROLYTE SECONDARY BATTERY AND BATTERY PACK

(71) Applicant: Kabushiki Kaisha Toshiba, Minato-ku (JP)

(72) Inventors: Yumiko KITA, Yokohama (JP); Asato KONDO, Yokohama (JP); Takashi KUBOKI, Ota (JP); Shinsuke MATSUNO, Minato (JP)

(73) Assignee: Kabushiki Kaisha Toshiba, Minato-ku (JP)

(21) Appl. No.: 15/079,065

(22) Filed: Mar. 24, 2016

(30) Foreign Application Priority Data
Mar. 25, 2015 (JP) 2015-062624

(51) Int. Cl. H01M 4/583; H01M 4/62; H01M 10/04; H01M 10/0525; H01M 10/42; H01M 4/133; H01M 4/38

(52) U.S. Cl. CPC H01M 4/583; H01M 4/133; H01M 4/622; H01M 4/386; H01M 10/0525; H01M 10/4257; H01M 10/0431; H01M 2004/027

(57) ABSTRACT

In one embodiment, a negative electrode for a nonaqueous electrolyte secondary battery is a negative electrode which is provided with a metal foil collector, and an negative electrode mixture layer formed on a surface of the metal foil collector, containing a negative electrode active material particle having a carbonaceous material and metal or an oxide of the metal dispersed in the carbonaceous material, a conductive agent, and a binding agent, and the negative electrode mixture layer has an average value of a cutting strength of not less than 0.6 kN/m, and a standard deviation of not less than 0.05 kN/m and not more than 0.2 kN/m, when the negative electrode mixture layer is cut at a portion distant from an interface in a prescribed horizontal direction, by a borazon blade with a blade width of 1 mm, at a rake angle θS of 20 degrees, and a relief angle θN of 10 degrees, and at a horizontal speed of 2 μm/sec.

### CROSS-REFERENCE TO RELATED APPLICATION

This application is based upon and claims the benefit of priority from the prior Japanese Patent Application No. 2015-062624, filed on Mar. 25, 2015, the entire contents of which are incorporated herein by reference.

### FIELD

Embodiments described herein relate generally to an electrode for a nonaqueous electrolyte secondary battery, a nonaqueous electrolyte secondary battery and a battery pack.

### BACKGROUND

Recently, various portable electronic devices have become widespread, by the rapid development of a miniaturization technology of an electronics device. And miniaturization is also required for batteries which are power sources for these portable electronic devices, and a nonaqueous electrolyte secondary battery having a high energy density has attracted attention.

A nonaqueous electrolyte secondary battery using metal lithium as a negative electrode active material has an extremely high energy density, but since a resinous crystal called dendrite is separated on a negative electrode at the time of charging, battery life is short, and there was also such a problem in safety that dendrite grows and reaches a positive electrode to cause internal short-circuit. Accordingly, as a negative electrode active material for replacing lithium metal, a carbon material to insert/extract lithium, particularly graphite carbon has been used.

In addition, as a negative electrode active material pursuing a further high energy density, an effort has been made to use particularly an element which is alloyed with lithium, such as silicon, tin, or a material having a large lithium insertion capacity and a high density, such an amorphous chalcogen compound. Among them, silicon can insert lithium up to a ratio of 4.4 lithium atoms to 1 silicon atom, and a negative electrode capacity per mass thereof is about 10 times that of graphite carbon.

But regarding silicon, change of the volume in accompany with insertion/extraction of lithium in a charge/discharge cycle is large, and deterioration of the cycle due to pulverization and so on is severe (Patent Document 1). In order to suppress the deterioration in accompany with the volume change, an advent of a material to perform stress mitigation so as to withstand expansion/contraction of the respective constituent elements, in order to ensure conductivity in an electrode mixture, has been expected, but now it is insufficient.

### BRIEF DESCRIPTION OF THE DRAWINGS

FIG. 1 is a conceptual diagram of a negative electrode according to a first embodiment.

FIG. 2 is a conceptual diagram of a nonaqueous electrolyte secondary battery according to a second embodiment.

FIG. 3 is an enlarged conceptual diagram of the nonaqueous electrolyte secondary battery according to the second embodiment.

FIG. 4 is a conceptual diagram of a battery pack of a third embodiment.

FIG. 5 is a block diagram showing an electric circuit of the battery pack of the third embodiment.

### DETAILED DESCRIPTION

Hereinafter, embodiments will be described.

### First Embodiment

### Electrode for Nonaqueous Electrolyte Secondary Battery

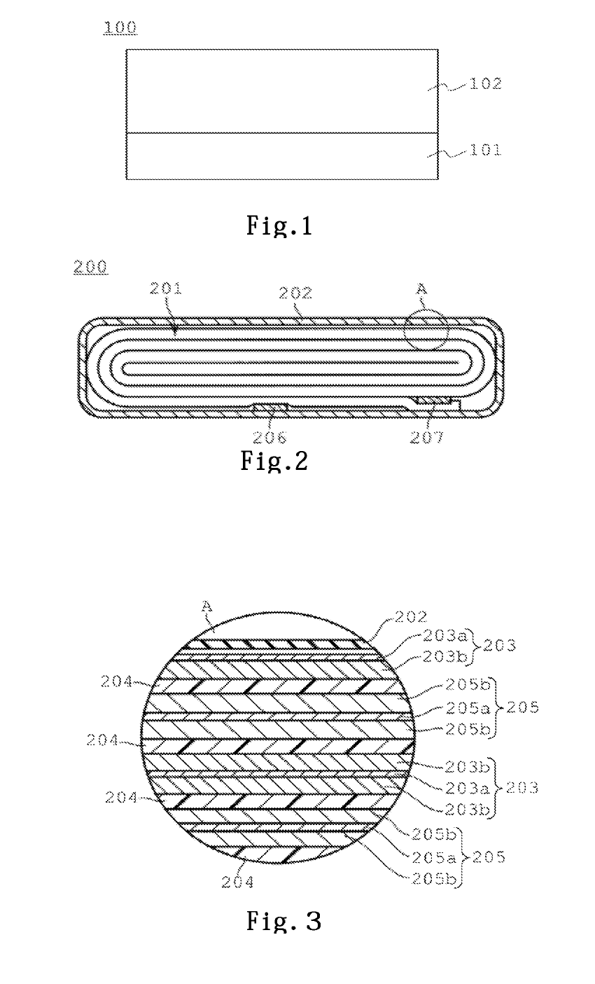

An electrode for a nonaqueous electrolyte of a first embodiment has a structure that an electrode mixture layer containing an electrode active material is carried on one surface or both surfaces of a collector. The electrode for a nonaqueous electrolyte of the first embodiment is used as a negative electrode, for example. FIG. 1 shows a sectional conceptual diagram of a negative electrode of the first embodiment. A negative of FIG. 1 is composed of a collector 101, and a negative electrode mixture layer 102 formed on one surface of the collector 101.

The negative electrode mixture layer 102 of the first embodiment is composed of a negative electrode active material, a conductive agent, and a binding agent. An additive agent other than the conductive agent may be contained in the negative electrode mixture layer 102. The electrode of the embodiment can be used for various kinds of batteries. In addition, the electrode of the embodiment can be used as a positive electrode.

A thickness of the negative electrode mixture layer 102 is preferably in a range of not less than 1.0 μm, and not more than 150 μm. Accordingly, when the negative electrode mixture layers 102 are carried on the both surfaces of the metal foil collector 101, the total thickness thereof becomes in a range of not less than 2.0 μm, and not more than 300 μm. A more preferable range of a thickness at one side is not less than 20 μm, and not more than 100 μm. When the thickness is in this range, a large current discharge characteristic and a cycle life are greatly improved.

Regarding a preferable mixing ratio of the active material, the conductive agent and the binding agent in the negative electrode mixture layer 102, the active material is in a range of not less than 80 mass, and not more than 95 mass %, the conductive agent is in a range of not less than 3 mass, and not more than 18 mass, the binding agent is in a range of not less than 2 mass, and not more than 7 mass. It is preferable to set the ratio to these ranges, because an excellent large current discharge characteristic and cycle life can be obtained.

As the negative electrode active material in the first embodiment, a carbonaceous material [cokes, graphites (natural graphite, artificial graphite, or the like), thermal decomposition carbons, a sintered body of an organic polymer compound, carbon fiber, active coal] which can insert/extract lithium metal, lithium alloy, and lithium, and at least one of an element selected from a group consisting of Si, Sn, Al, In, Ga, Pb, Ti, Ni, Mg, W, Mo, and Fe, an alloy thereof and its oxide can be used, by one kind or combination of two or more kinds. In addition, an element other than the above-described elements may be contained in the alloy.

Out of these, a desirable aspect of the negative electrode active material according to the first embodiment is a particle in which composite bodies are finely compounded. Here, in the composite body, microcrystal Si is dispersed in the carbonaceous material, in the state that the microcrystal Si is contained or held in a Si oxide phase containing which is tightly bound with Si, in an active material formed by compounding and burning minute silicon monoxide and carbonaceous material. Further, an average size of the silicon oxide phase which holds and contains Si is preferably not less than 50 nm, and not more than 1000 nm, and also the silicon oxide phase preferably exists to be dispersed in the carbonaceous material in a uniform state that, in a standard deviation in which the size distribution is defined as (d84%−d16%)/2, a value of (standard deviation/average size) is not more than 1.0.

A large amount of lithium is inserted in and extracted from the silicon phase, and thereby the silicon phase increases a capacity of the negative electrode active material. Expansion and contraction caused by insertion/extraction of a large amount of lithium into the silicon phase is alleviated, by dispersing the silicon phase into the silicon oxide phase and the carbonaceous material, and thereby the active material particles are prevented from being pulverized, and in addition, the carbonaceous material phase ensures the conductivity important as the negative electrode active material, and the silicon oxide phase is tightly bound with silicon, and has a large effect for maintaining the particle structure, as a buffer for holding micronized silicon.

The silicon phase largely expands and contracts at the time of inserting and extracting lithium, and accordingly in order to reduce this stress, the silicon phase is preferably miniaturized and dispersed as much as possible. Specifically, the silicon phase is preferably dispersed in a cluster of several nm, to a size of not more than 100 nm even if it is large.

The silicon oxide phase has an amorphous structure, a crystalline structure or the like, and is preferably dispersed uniformly in the active material particles in a state that it combines with the silicon phase and contains or holds the silicon phase. But, the Si microcrystals held by the silicon oxide combine with each other and thereby a crystallite size grows, while repeating volume change by inserting and extracting Li at the time of charge/discharge, and thereby capacity decrease and initial charge/discharge efficiency reduction are caused. Accordingly, in the present invention, a size of the silicon oxide phase is made small and uniform, and the growth of the crystallite size of the microcrystal Si is blocked, and thereby capacity deterioration due to the charge/discharge cycle is suppressed, and the life characteristic is improved. The preferable average size of the silicon oxide phase is in a range from 50 nm to 1000 nm. In addition the size of the phase is a value of a diameter of the circle, when a section of the phase is converted into a circle having an area corresponding to an area of the cross section of the phase. If larger than this range, an effect for suppressing the growth of the size of the microcrystal Si cannot be obtained. In addition, if smaller than this range, at the time of manufacturing the active material, it becomes difficult to disperse the silicon oxide phase, and in addition, problems such as the decrease in the rate characteristic due to the reduction of the conductivity as the active material, and the decrease in the initial charge/discharge capacity efficiency are caused. More preferably, the average size is not less than 100 nm and not more than 500 nm, and if the average size is in this range, it is possible to obtain a particularly good life characteristic. In addition, in order to obtain a good characteristic as the whole active material, the size of the silicon oxide phase is preferably uniform, and when 16% accumulation diameter of the volume component is d16%, and 84% accumulation diameter thereof is d84%, and for a standard deviation indicated by (d84%−d16%)/2, a value of (standard deviation/average size) is preferably not more than 1.0, and further, when this value is not more than 0.5, an excellent life characteristic can be obtained.

As the carbonaceous material which is compound with the silicon phase and the silicon oxide phase in the particle, graphite, hard carbon, soft carbon, amorphous carbon, or acetylene black or the like may be used, and one or a mixture of several kinds may be used, and preferably only graphite, or a mixture of graphite and hard carbon may be used. Graphite is preferable in the point to enhance conductivity of an active material, and coats the whole hard carbon active material, and thereby has an effect to largely reduce the expansion and contraction thereof. The carbonaceous material is preferably in a shape to include the silicon phase, and the silicon oxide phase. In addition, in a composite body in which the silicon oxide phases of a micro particle is dispersed, in order to hold the structure of the particle, and prevent aggregation of the oxide silicon phase, and ensure the conductivity, the composite body preferably contains carbon fiber. Accordingly, it is effective, if a diameter of the carbon fiber to be added is about the same size as the silicon oxide phase, and the average size thereof is preferably not less than 50 nm, and not more than 1000 nm, and more preferably, it is not less than 100 nm, and not more than 500 nm. The content amount of the carbon fiber is preferably in a range of not less than 1 mass, and not more than 8 mass, and more preferably, it is in a range of not less than 0.5 mass %, and not more than 5 mass.

In addition, lithium silicate such as Li₄SiO₄ may be dispersed on the surface or the inside of the silicon oxide phase. It is thought that lithium salt added to the carbonaceous material is subjected to heat treatment, and thereby solid reaction with the silicon oxide phase in the composite body is caused to form lithium silicate.

In the carbonaceous material of a structure to cover the silicon phase and the silicon oxide phase, a SiO₂ precursor and a Li compound may be added. These materials are added in the carbonaceous material, and thereby the binding of SiO₂ generated from the silicon monoxide and the carbonaceous material is strengthened, and Li₄SiO₄ excellent in Li ion conductivity is generated in the silicon oxide phase. As the SiO₂ precursor, alkoxide such as silicon ethoxide can be listed. As the Li compound, lithium carbonate, lithium oxide, lithium hydroxide, lithium oxalate, lithium chloride can be listed.

A particle diameter of the negative electrode active material is preferably not less than 5 μm, and not more than 100 μm, and particularly not more than 20 μm. Further, a specific surface area thereof is preferably not less than 0.5 m²/g, and not more than 10 m²/g. The particle diameter and the specific surface area of the active material affect an insertion/extraction reaction of lithium, and have a significant effect to the negative electrode characteristic, but if they are values within these ranges, the active material can stably exert its characteristic.

In addition, a half-value width of a diffraction peak on a Si (220) surface in a powder X-ray diffraction measurement of the active material is preferably not less than 1.5°, and not less than 8.0°. The half-value width of the diffraction peak on the Si (220) surface becomes smaller, as the crystal particle of the silicon phase grows more, and when the crystal particle of the silicon phase grows large, breaking might easily be generated in the active material particle, in accordance with expansion and contraction in accompany with the insertion/extraction of lithium, but if the half-value width is within the range of not less than 1.5°, and not less than 8.0°, it can be avoided that such a problem is revealed.

Regarding a ratio among the silicon phase, the silicon oxide phase, the carbonaceous material phase, a mole ratio of Si and carbon is preferably in a range that 0.2≦Si/carbon≦2. Regarding the quantitative relation between the silicon phase and the silicon oxide phase, it is preferable that the mole ratio thereof is 0.6≦Si/SiO₂≦1.5, because a large capacity and an excellent cycle characteristic can be obtained as the negative electrode active material.

In addition, the negative electrode mixture layer 102 may contain a conductive agent. As the conductive agent, acetylene black, carbon black, graphite or the like can be listed.

As the collector 101, a conductive substrate of a porous structure or a nonporous conductive substrate can be used. These conductive substrates can be formed of copper, stainless-steel or nickel, for example. A thickness of the collector 101 is preferably not less than 5 μm, and not more than 20 μm. This is because, if the thickness is in this range, the balance between electrode strength and weight saving can be obtained. Out of these substrates, copper containing copper alloy is the most preferable from the point of conductivity.

The negative electrode mixture layer 102 contains a binding agent for binding the negative electrode materials to each other. As the binding agent, polysaccharide, such as polytetrafluoroethlene (PTFE), polyvinylidene fluoride (PVdF), polyacrylic acid, algin acid, cellulose, and its derivative, ethylene-propylene-diene copolymer (EPDM), styrene-butadiene rubber (SBR), polyimide, polyamide, polyamide-imide or the like can be used. Among them, a polymer having an imide group, such as polyimide is more preferable from the viewpoint of the high binding force of the collector, and the negative electrode materials themselves. When polyimide is used, 10 pts. wt. is preferable from the viewpoint of adhesiveness, and when a binding agent except polyimide is used, 12 pts. wt. or more is preferable. In addition, two or more kinds of biding agents may be used in combination, and when a combination of a binding agent excellent in binding of the active materials themselves, and a binding agent excellent in biding of the active material and the collector 101 is used, or a binding agent with a high hardness and a binding agent excellent in flexibility are used in combination, the negative electrode 100 excellent in a life characteristic can be manufactured.

A cutting strength of an interface between the collector 101 and the negative electrode mixture 102 is set to a, and as a method of evaluating a cutting strength in a prescribed horizontal direction in the above-described negative electrode mixture layer 102, there is a test of a SAICAS (SAICAS: Surface And Interfacial Cutting Analysis System) method. This is a method in which a surface of a sample is cut by a minute and sharp cutting blade, while controlling a depth position thereof, and a stress applied to the blade is measured.

In a cutting measurement value of the interface of the collector 101 and the negative electrode mixture layer 102, a friction resistance caused by contacting of the cutting blade with the surface of the collector 101 is included.

### <Evaluation Apparatus>

### SAICAS: Surface and Interfacial Cutting Analysis System

Name of installation company: DAIPLA WINTES CO., LTD.
Name of apparatus type: DN-GS
Measurement method: Measurement was performed in a condition by a SAICAS evaluation method listed in Table 1.

TABLE 1

| | cutting test |
|---|---|
| measurement mode | constant speed mode |
| type of cutting blade | BN borazon |
| blade width (mm) | 1 |
| rake angle (°) | 20 |
| relief angle (°) | 10 |
| vertical displacement | cutting blade support table |
| measuring point | |
| horizontal speed (μm/sec.) | 2 |
| vertical speed (μm/sec.) | 0.2 |
| pressing load (N) | — |
| balance load (N) | — |
| shear angle (degree) | 45 |

### <Measurement Method>

The negative electrode 100 was cut off at 20 mm square, to prepare a sample for SAICAS evaluation. A cutting strength of the evaluation sample was measured by a cutting strength measurement apparatus SAICAS (registered trademark) DN-GS (made by DAIPLA WINTES CO., LTD.). A ceramic blade of a borazon material was used as the cutting blade, and a cutting strength thereof was measured, in a condition that a blade width is 1.0 mm, regarding an angle of the blade, a rake angle is 20 degrees, a relief angle is 10 degrees, a speed thereof is a constant speed of a vertical speed of 0.2 μm/sec, a horizontal speed of 2 μm/sec. In addition, a new blade was used as the borazon blade to be used, and it was confirmed that any is free from defects in advance. The measurement was performed in a condition that a measurement temperature was the room temperature of 25° C., and a sample (electrode) temperature was also 25° C. Regarding the measurement of the cutting strength, the electrode mixture layer at a prescribed area which is separate from the surface of the electrode mixture layer by not less than 0.2 μm, for example, at a prescribed area separate by 0.2 μm, is measured. (It is preferable to measure a central portion of the electrode mixture, or 1/3, 2/3 portions from the bottom of the mixture.)

Regarding a calculation method of a cutting strength, an average value from a value after 20 sec. to a value after 200 sec. in a definite depth direction is calculated. It is characterized that an average value of the cutting strength calculated this time is not less than 0.6 kN/m, and not more than 2.0 kN/m.

Regarding the calculation method of the cutting strength, a value may be calculated from a value after 20 sec. to a value after 200 sec. in a definite depth direction by a data software of the SAICAS apparatus, but a data processing is executed separately, and an average value may be calculated by the data at this time.

In addition, a method of obtaining a standard deviation is as described in the following expression (1).

$$\begin{matrix}[ Number 1 ] & \\ standard deviation \text{:} & \\ σ = \sqrt{\frac{1}{n} {\sum }_{i = 1}^{n} {( {x}_{i} - μ )}^{2}} & Expression ( 1 )\end{matrix}$$

n: number of data

xi: actual measurement data at a time i

μ: an average value of the actual measurement data

### Second Embodiment

### Structure of Nonaqueous Electrolyte Secondary Battery

A nonaqueous electrolyte secondary battery according to a second embodiment will be described. In addition, in the following description of the embodiment, the description of the same portions as the portions described in the first embodiment were omitted.

A nonaqueous electrolyte secondary battery according to a second embodiment is provided with an exterior material, a positive electrode which is housed in the external material, a separator which is housed in the external material, a negative electrode, containing an active material, which is housed in the external material spatially separately from the positive electrode, with the separator being interposed therebetween, and nonaqueous electrolyte filled in the exterior material.

A nonaqueous electrolyte secondary battery 200 according to the embodiment will be described in detail, with reference to conceptual diagrams of FIG. 2, FIG. 3 showing an example thereof. FIG. 2 is a conceptual sectional diagram of the flat nonaqueous electrolyte secondary battery 200 with a bag-like exterior material 202 composed of a laminate film, and FIG. 3 is an enlarged sectional diagram of an A portion of FIG. 2.

In addition, each diagram is a conceptual diagram for explanation, and the shape, dimension and ratio thereof may be different from those of the actual device, but it is possible to appropriately change the design of these by taking into consideration of the following description and prior arts.

A flat wound electrode group 201 is housed in the bag-like exterior material 202 composed of a laminate film in which an aluminum foil is interposed between two resin layers. The flat wound electrode group 201 is formed by winding a laminate in which a negative electrode 203, a separator 204, a positive electrode 205, the separator 204 are laminated in this order from the outer side in a spiral shape, and by performing press forming of the wound laminate. The negative electrode 203 at the outermost shell has a structure that a negative electrode mixture 203b is formed on one side at an inner surface side of a negative electrode collector 203a as shown in FIG. 3. The other negative electrode 203 is configured such that the negative electrode mixtures 203b are formed on both sides of the negative electrode collector 203a. An active material in the negative electrode mixture 203b contains an active material for the battery 200 according to the second embodiment. The positive electrode 205 is configured such that positive electrode mixtures 205b are formed on both sides of a positive electrode collector 205a.

At the vicinity of an outer circumferential end of the wound electrode group 201, a negative electrode terminal 206 is electrically connected to the negative electrode collector 203a of the negative electrode 203 at the outermost shell, and a positive electrode terminal 207 is electrically connected to the positive electrode collector 205a of the positive electrode 205 at an inner side. The negative electrode terminal 206 and the positive electrode terminal 207 are extended outside from opening portions of the bag-like exterior material 202. For example, liquid nonaqueous electrolyte is injected from an opening portion of the bag-like exterior material 202. The openings of the bag-like exterior material 202 are heat sealed while the negative electrode terminal 206 and the positive electrode terminal 207 are sandwiched, and thereby the wound electrode group 201 and the liquid nonaqueous electrolyte are completely sealed.

As the negative electrode terminal 205, aluminum or aluminum alloy containing an element of Mg, Ti, Zn, Mn, Fe, Cu, Si or the like can be listed, for example. It is preferable that the negative electrode terminal 206 is made of the same material as the negative electrode collector 203a, so as to reduce a contact resistance with the negative electrode collector 203a.

As the positive electrode terminal 207, a material which is provided with electric stability and electrical conductivity in the state that a potential to a lithium ion metal is in a range from 3V to 4.25 V, can be used. Specifically, aluminum or aluminum alloy containing an element of Mg, Ti, Zn, Mn, Fe, Cu, Si or the like can be listed. It is preferable that the positive electrode terminal 207 is made of the same material as the positive electrode collector 205a, so as to reduce a contact resistance with the positive electrode collector 205a.

Hereinafter, the bag-like exterior material 202, the positive electrode 205, the negative electrode 203, the electrolyte, the separator 204 which are the constituent members of the nonaqueous electrolyte secondary battery 200 will be described in detail.

### 1) Bag-Like Exterior Material 202

The bag-like exterior material 202 is formed of a laminate film with a thickness of not more than 0.5 mm. Or, as the exterior material, a metal container with a thickness of not more than 1.0 mm is used. More preferably, the metal container has a thickness of not more than 0.5 mm.

A shape of the bag-like exterior material 202 can be selected from a flat type (thin type), a square type, a cylinder type, a coin type, and a button type. In an example of the exterior material, an external material for a small type battery which is to be mounted on a portable electronic device or the like, for example, and an external material for a large type battery which is to be mounted on a two-wheel to four-wheel car or the like are included, according to a size of the battery.

As the laminate film, a multi-layer film in which a metal layer is interposed between resin layers is used. The metal layer is preferably an aluminum foil or an aluminum alloy foil for weight reduction. As the resin layer, a polymer material, such as polypropylene (PP), polyethylene (PE), nylon, polyethylene-terephthalate (PET) or the like can be used. The laminate film is sealed by heat fusion, and thereby can be formed in a shape of the exterior material.

The metal container is made of aluminum or aluminum alloy or the like. The aluminum alloy is preferably an alloy containing an element, such as magnesium, zinc, silicon or the like. When transition metal, such as iron, copper, nickel, chrome or the like is contained in the alloy, its amount is preferably set to not more than 100 ppm.

### 2) Positive Electrode 205

The positive electrode 205 has a structure that the positive electrode mixture 205b containing the active material is carried on one side or both sides of the positive electrode collector 205a.

It is preferable that a thickness of the above-described positive electrode mixture 205b at one side is in a range of not less than 1.0 μm, and not more than 150 μm, from the point of holding a large current discharge characteristic and a cycle life of the battery. Accordingly, when the positive electrode mixtures 205b are carried on the both surfaces of the positive electrode collector 205a, the total thickness is preferably in a range of not less than 20 μm, and not more than 200 μm. A more preferable range of a thickness at one side is not less than 20 μm, and not more than 120 μm. When the thickness is within this range, the large current discharge characteristic and the cycle life are improved.

The positive electrode mixture 205b may contain a conductive agent, in addition to the positive electrode active material.

In addition, the positive electrode mixture 205b may contain a binding agent for binding the positive electrode materials to each other.

It is preferable that various oxides, such as manganese dioxide, lithium manganese composite oxide, lithium-containing cobalt oxide (LiCOO₂, for example), lithium-containing nickel cobalt oxide (LiNi_{0.8}CO₀, for example), lithium manganese composite oxide (LiMn₂O₄, LiMnO₂) are used, as the positive electrode active material, because high voltage can be obtained.

As the conductive agent, acetylene black, carbon black, graphite or the like can be listed. As a specific example of the binding agent, polytetrafluoroethlene (PTFE), polyvinylidene fluoride (PVdF), ethylene-propylene-diene copolymer (EPDM), styrene-butadiene rubber (SBR) or the like can be used, for example.

Regarding a preferable mixing ratio of the active material, the conductive agent and the binding agent in the positive electrode mixture 205b, the active material is in a range of not less than 80 mass %, and not more than 95 mass %, the conductive agent is in a range of not less than 3 mass, and not more than 18 mass, and the binding agent is in a range of not less than 2 mass, and not more than 7 mass. It is preferable that these ranges are set, because an excellent large current discharge characteristic and cycle life can be obtained.

As the collector 205a, a conductive substrate of a porous structure or a nonporous conductive substrate can be used. A thickness of the collector 205a is preferably not less than 5 μm, and not more than 20 μm. This is because, if the thickness is in this range, the balance between an electrode strength and weight saving can be obtained.

The positive electrode 205 is manufactured by suspending the active material, the conductive agent and the binding agent in a generally used solvent to prepare slurry, applying this slurry to the collector 205a, and drying, and then pressing the dried matter. The positive electrode 205 may be manufactured by forming the active material, the conductive agent and the binding agent in a pellet shape to obtain the positive electrode mixture 205b, and by forming this on the collector 205a.

Regarding a mixing ratio of the active material, the conductive agent and the binding agent in the positive electrode mixture, it is preferable to set ranges, of not less than 80 mass, and not more than 95 mass % for the active material, not less than 3 mass, and not more than 18 mass % for the conductive agent, and not less than 2 mass, and not more than 7 mass % for the binding agent, because an excellent large current discharge characteristic and cycle life can be obtained.

### 3) Negative Electrode 203

The negative electrode 100 of the first embodiment is used as the negative electrode 203.

The negative electrode 203 has a structure that the negative electrode mixture layer 203b containing the negative electrode active material and other negative electrode material is carried in the form of a layer on one side or both sides of the negative electrode collector 203a.

As a method of manufacturing the negative electrode 203 of the embodiment, a method is listed such that two kinds of slurries having different binding agent density are applied to the collector 203a, and then they are subjected to compression molding. Regarding the binding agent density, specifically a binding agent density of the slurry to be firstly applied to the collector is made lower, and a binding agent density of the slurry to be secondly applied is made higher. The binding agent density of the second slurry is preferably not less than 1.5 times, and not more than 5.0 times, compared with the binding agent density of the first slurry. If the density magnification ratio is less than 1.5 times, an effect given to the difference of binding agent density distribution is small. In addition, if the first binding agent density is too high, the charge/discharge capacity might be decreased. A first slurry application depth/second slurry application depth is preferably not less than 0.01, and not more than 1.0, for example. If the first slurry application ratio is too small, that is not preferable, since the non-uniformity thereof increases, and as a result, the variation in binding strength with the collector in the electrode might be generated. If the second slurry application ratio is too small, that is not preferable, since the adhesiveness with the collector in the normal charge/discharge region might also be decreased, and as a result, the charge/discharge cycle is adversely affected. After the second slurry application, a compression molding is performed thereto. This compression is performed by a roll press or the like having a compression force of not less than 1.0 kN/cm.

### 4) Electrolyte

As the electrolyte, nonaqueous electrolyte solution, electrolyte impregnated type polymer electrolyte, polymer electrolyte, or inorganic solid electrolyte can be used. The nonaqueous electrolyte solution is a liquid electrolyte solution which is prepared by dissolving the electrolyte in a nonaqueous solvent, and is held in voids in the electrode group.

As the nonaqueous solvent, a nonaqueous solvent mainly containing a mixed solvent of propylene carbonate (PC) and ethylene carbonate (EC), and a nonaqueous solvent (hereinafter referred to as a second solvent) having a lower viscosity than PC and EC is preferably used.

As the second solvent, chain carbon is preferable, for example, and in the chain carbon, dimethyl carbonate (DMC), methyl ethyl carbonate (NEC), diethyl carbonate (DEC), ethyl propionate, methyl propionate, γ-butyrolactone (BL), acetonitrile (AN), ethyl acetate (EA), toluene, xylene, or methyl acetate (MA), or the like can be listed. These second solvents can be used solely or in the form of a mixture of two or more kinds. Particularly, the second solvent in which the number of donors is not more than 16.5 is more preferable.

A viscosity of the second solvent is preferably not more than 2.8 cp at 25° C. A blending amount of ethylene carbonate or propylene carbonate in the mixed solvent is preferably not less than 1.0%, and not more than 80% by volume ratio. A more preferable blending amount of ethylene carbonate or propylene carbonate is not less than 20%, and not more than 75% by volume ratio.

As the electrolyte contained in the nonaqueous electrolyte solution, lithium salt (electrolyte), such as lithium perchlorate (LiClO₄), lithium hexafluorophosphate (LiPF₆), lithium borofluoride (LiBF₄), lithium arsenic hexafluoride (LiAsF₆) lithium trifluoromethanesulfonate (LiCF₃SO₃), bis-trifluoromethylsulfonyl imide lithium [LiN(CF₃SO₂)₂] is listed. Out of them, it is preferable to use LiPF₆, LiBF₄.

An amount of dissolution of the electrolyte to the nonaqueous solvent is preferably not less than 0.5 mol/l, and not more than 2.0 mol/l.

### 5) Separator 204

When the nonaqueous electrolyte solution is used, and when the electrolyte impregnated polymer electrolyte is used, the separator 204 can be used. A porous separator is used as the separator 204. As the material of the separator 204, a porous film containing polyethylene, polypropylene, or polyvinylidene fluoride (PVdF), synthetic resin nonwoven fabric or the like can be used. Above all, a porous film of polyethylene, or polypropylene, or a porous film formed of the both is preferable, because the safety of a secondary battery can be improved.

A thickness of the separator 204 is preferably set to not more than 30 μm. If the thickness exceeds 30 μm, an internal resistance might be increased, because a distance between the positive and negative electrodes is increased. In addition, a lower limit value of the thickness is preferably set to 5 μm. If the thickness is set to less than 5 μm, the strength of the separator 204 is considerably decreased, and thereby an internal short might easily be generated. An upper limit value of the thickness is more preferably set to 25 μm, and a lower limit value of the thickness is more preferably set to 1.0 μm.

A heat shrinkage percentage of the separator 204 is preferably not more than 20% when held for one hour on the condition of 120° C. If the heat shrinkage percentage exceeds 20%, a possibility to cause short circuit by heating increases. It is more preferable to set the heat shrinkage percentage to not more than 15%.

A porosity of the separator 204 is preferably in a range of not less than 30%, and not more than 70%.

This is because of the following reason. If the porosity is set to less than 30%, it might become difficult to obtain a high electrolyte holding property in the separator 204. On the other hand, if the porosity exceeds 70%, the sufficient strength of the separator 204 might not be obtained. A more preferable range of the porosity is not less than 35%, and not more than 60%.

An air permeability of the separator 204 is preferably not more than 500 second/1.00 cm³. If the air permeability exceeds 500 second/1.00 cm³, it might become difficult to obtain a high lithium ion mobility in the separator 204. In addition, a lower limit value of the air permeability is 30 second/1.00 cm³. This is because, if the air permeability is set to less than 30 second/1.00 cm³, the sufficient strength of the separator might not be obtained.

An upper limit value of the air permeability is more preferably set to 300 second/1.00 cm³, and a lower limit value is more preferably set to 50 second/1.00 cm³.

### Third Embodiment

Next, a battery pack according to a third embodiment will be described.

A battery pack according to the third embodiment has one or more nonaqueous electrolyte secondary batteries (that is, unit battery) according to the above-described second embodiment. When a plurality of unit batteries are included in the battery pack, the respective unit batteries are arranged to be electrically connected in series, in parallel, or in series and parallel.

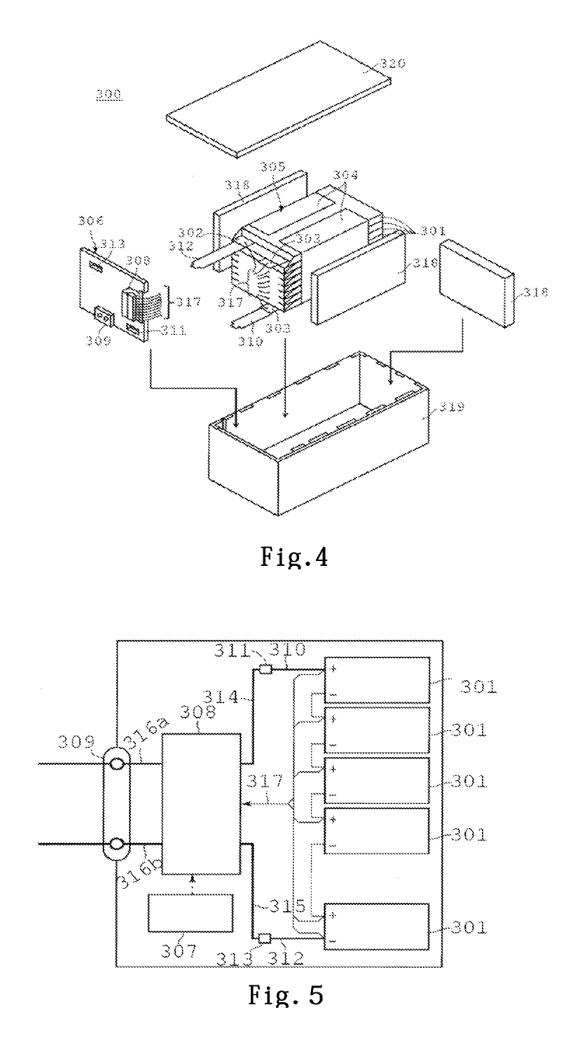

FIG. 4 is a conceptual diagram of the battery pack of the third embodiment, and FIG. 5 is a block diagram showing an electric circuit of the battery pack according to the third embodiment. A battery pack 300 shown in FIG. 4 uses the nonaqueous electrolyte secondary battery 200 shown in FIG. 2, as a unit battery 301.

A plurality of the unit batteries 301 are laminated so that negative electrode terminals 302 and positive electrode terminals 303 which extend outside are aligned in the same direction, and are bound by an adhesive tape 304, to compose an assembled battery 305. These unit batteries 301 are electrically connected in series with each other, as shown in FIG. 4 and FIG. 5.

A printed wiring board 306 is arranged to face side surfaces of the unit batteries 301 from which the negative electrode terminals 302 and the positive electrode terminals 303 extend. A thermistor 307, a protection circuit 308 and a terminal 309 for conduction to an external device are mounted on the printed wiring board 306, as shown in FIG. 5. In addition, an insulating plate (not shown) is attached to a surface of the printed wiring board 306 facing the assembled battery 305, so as to avoid unnecessary connection with the wiring of the assembled battery 305.

A positive electrode side lead 310 is connected to the positive electrode terminal 303 located at the lowermost layer of the assembled battery 305, and its tip is inserted into a positive electrode side connector 311 of the printed wiring board 306, and is electrically connected thereto. A negative electrode side lead 312 is connected to the negative electrode terminal 302 located at the uppermost layer of the assembled battery 305, and its tip is inserted into a negative electrode side connector 313 of the printed wiring board 306, and is electrically connected thereto. The positive electrode side connector 311, the negative electrode side connector 313 are connected to the protection circuit 308 through wirings 314, 315 formed in the printed wiring board 306, respectively.

The thermistor 307 is used for detecting a temperature of the unit battery 305, and though the illustration thereof is omitted in FIG. 4, it is provided in the vicinity of the unit battery 305, and its detection signal is transmitted to the protection circuit 308. The protection circuit 308 can break a plus side wiring 316a and a minus side wiring 316 between the protection circuit 308 and the terminal 309 for conduction to an external device, under a prescribed condition. The prescribed condition is a time when a detection temperature of the thermistor 307 becomes not less than a prescribed temperature, for example. In addition, the prescribed condition is a time when over-charge, over-discharge, overcurrent or the like of the unit battery 301 is detected. Detection of this over-charge or the like is performed for each unit battery 301, or for the whole unit batteries 301. In the case of detecting each of the unit batteries 301, a battery voltage may be detected, or a positive electrode potential or a negative electrode potential may be detected. In the case of the latter, a lithium electrode which is used as a reference electrode is inserted in each of the unit batteries 301. In the case of FIG. 4 and FIG. 5, wirings 317 for voltage detection are connected to the respective unit batteries 301, and the detection signals are transmitted to the protection circuit 308 through these wirings 317.

As shown in FIG. 4, at three side surfaces of the assembled battery 305 except a side surface from which the positive terminals 303 and the negative terminals 302 project, protection sheets 318 composed of rubber or resin are respectively arranged.

The assembled battery 305, along with the respective protection sheets 318 and the printed wiring board 306 are housed in a housing container 319. That is, the protection sheets 318 are respectively arranged on the both inner side surfaces in the long side direction, and on an inner side surface in the short side direction, and the printed wiring board 306 is arranged on an inner side surface at the opposite side in the short side direction. The assembled battery 305 is located in a space surrounded by the protection sheets 318 and the printed wiring board 306. A lid 320 is attached on an upper surface of the housing container 319.

In addition, a heat shrinkable tape may be used, in place of the adhesive tape 304, for fixing of the assembled battery 305. In this case, the protection sheets are arranged at the both side surfaces of the assembled battery, and a heat shrinkable tape is wound around them, and then the heat shrinkable tape is thermally shrunk, to bind the assembled battery.

In FIG. 4, FIG. 5, a configuration in which the unit batteries 301 are connected in series is shown, but in order to increase battery capacity, they may be connected in parallel, or the series connection and parallel connection thereof may be combined. Assembled battery packs can be further connected in series, parallel.

According to the present embodiment as described above, the battery pack is provided with the nonaqueous electrolyte secondary batteries having an excellent charge/discharge cycle performance in the above-described second embodiment, and thereby it is possible to provide the battery pack having an excellent charge/discharge cycle performance.

In addition, an aspect of the battery pack is appropriately changed according to its usage. As a usage of the battery pack, one is preferable to show an excellent cycle performance, when a large current is extracted. Specifically, a usage for a power source for a digital camera, and a usage for an onboard use, such as a two-wheel to four-wheel hybrid electric car, a two-wheel to four-wheel electric car, an assist bicycle or the like, can be listed. In particular, the battery pack using the nonaqueous electrolyte secondary battery excellent in a high temperature characteristic can be suitably used as an onboard use.

Hereinafter, specific examples will be listed, and the effects thereof will be described.

### EXAMPLES

### Example 1

Silicon powder (average particle diameter 20 nm) was used as a particle containing a silicon atom, and sucrose powder was added to the silicon powder, and they were subjected to a dry mixing in an agate mortar. Next, ethanol was added to this mixed powder, and they were kneaded. The kneaded matter obtained like this was housed in an alumina container, and was left on a hot plate of 150° C. for two and a half hours, to be dried. The obtained solidified matter was held in an Ar atmosphere at 1000° C. for six hours, to be burned. The material after the burning was pulverized, and thereby a negative electrode active material of −20 micrometers was obtained by sieving.

### <Charge/Discharge Test>

50 mass % graphite having an average particle diameter of μm, 12 mass % polyimide were kneaded with the obtained negative electrode material, using N-methylpyrrolidone as a disperse medium, and they were applied on an SUS foil with a thickness of 11 μm, and rolled, and then the rolled matter was subjected to heat treatment in an Ar gas, at 250° C. for 2 hours, and further at 400° C. for 1 hour, and was cut into a prescribed size, and then dried in vacuum at 130° C. for 12 hours, and thereby a test electrode was obtained. A battery in which counter electrodes and a reference electrode are made of metal Li, an electrolyte solution is an EC/DEC (volume ratio EC:DEC=1:2) solution of LiPF₆ (1M) was manufactured in an argon atmosphere, and a charge/discharge test thereof was performed. Regarding the condition of the charge/discharge test, charging was performed at a current density of 1 mA/cm² until 0.01 V of the potential difference between the reference electrode and the test electrode, and further constant voltage charging was performed at 0.01 V for 24 hours, and discharging was performed at a current density of 1 mA/cm² until 1.5 V. Further, a cycle to perform charging at a current density of 1 mA/cm² until 0.01 V of the potential difference between the reference electrode and the test electrode, and to perform discharging at a current density of 1 mA/cm² until 1.5 V was performed, and a transition of the discharge capacity was measured. An evaluation was performing, wherein the number of the cycles in which the discharge capacity can maintain 80% of the initial discharge capacity is determined as a cycle life.

In addition, the manufactured electrode was cut off at 20 mm square, to prepare a sample for cutting strength evaluation. The evaluation sample was cut by a cutting strength measurement apparatus SAICAS DN-GS type (made by DAIPLA WINTES CO., LTD.), in the condition that regarding the cutting strength of an interface of the negative electrode mixture layer and the collector, at a constant load mode of 0.5 N, and regarding the cutting strength in the negative electrode mixture, it was fixed at a depth of a half of the thickness of the negative electrode mixture, and then each was cut at a speed of a horizontal speed of 2 μm/sec, and a cutting strength from a force from the horizontal direction necessary for cutting was measured. The result is shown in Table 1.

Regarding the following examples and comparative examples, only portions different from the example 1 will be described, and since other composition and evaluation procedure were performed in the same manner as the example 1, the description thereof will be omitted.

### Example 2

The sample was left on a hot plate of 150° C. for two hours, in the same method as the example 1, to be dried. The obtained solidified matter was held in an Ar atmosphere at 1100° C. for four hours, to be burned. The material after burning was pulverized, and thereby a negative electrode active material of −20 micrometers was obtained by sieving.

15 mass % graphite, 16 mass % polyimide similarly as the binder were added to this, and thereby an electrode was obtained. The electrode similarly manufactured was cut off at mm square, to prepare a sample for cutting strength evaluation, and a cutting strength measurement was performed to the sample.

### Example 3

To begin with, silicon fine particles with an average particle diameter of 40 nm were inputted in a crucible, and were subjected to heat treatment in an Ar atmosphere at 120° C. for two hours, and thereby a silicon sintered body was obtained.

Next, slurry containing crushed particles and a carbon material was formed, using the obtained silicon sintered body, in a procedure indicated below.

To begin with, 1.75 g resol resin (carbon precursor) that becomes a carbon material was dissolved in 10 g ethanol (dispersion medium), to obtain a dispersion solution. And, the dispersion solution and 1.25 g silicon sintered body were subjected to liquid phase mixing, using a planet ball mill, using balls consisting of ZrO₂, and the silicon sintered body was pulverized, to obtain slurry. Then the balls contained in the slurry were removed by a filtering method, and this slurry was dried at 120° C. to remove ethanol, and was heated at 150° C. for two hours, and thereby a composite body of the crushed particles and the carbon precursor (hard carbon (hardly graphitizable carbon)) was obtained (compounding process).

Next, the obtained composite body was burned in an Ar atmosphere at 1100° C. for three hours, using an electric furnace (burning process), to obtain a negative electrode active material. Subsequently, the obtained negative electrode active material was pulverized, and was sieved using a sieve with a mesh size of 20 μm, and thereby a negative electrode active material of the example 3 with a particle diameter of not more than 20 μm.

Using this negative electrode active material, 50 mass % graphite, 16 mass % polyimide similarly as the binder were added to this, and thereby an electrode was obtained. The electrode similarly manufactured was cut off at 20 mm square, to prepare a sample for a charge/discharge test, and cutting strength evaluation, and a cutting strength measurement was performed to the sample.

### Example 4

A negative electrode active material was manufactured in the same method as the example 3, except that a temperature and a time of the heat treatment in the burning process were set to 1100° C. and two hours. Using the negative electrode active material, 50 mass % graphite, 16 mass % polyimide similarly as the binder were added to this, and thereby an electrode was obtained. The electrode similarly manufactured was cut off at 20 mm square, to prepare a sample for a charge/discharge test, and cutting strength evaluation, and a cutting strength measurement was performed to the sample.

### Example 5

A point that is different from the example 1 is only that the binder amount was 10 mass.

### Example 6

A point that is different from the example 1 is only that the binder amount was 19 mass.

### Comparative Example 1

An electrode was manufactured on an aluminum foil, using hard carbon as the negative electrode active material and PVdF as the binder. Using this, the charge/discharge test and the cutting strength measurement were performed similarly as in the example 1.

### Comparative Example 2

2.2 g furfuryl alcohol, 20 g ethanol were added to 1.5 g silicon powder (average particle diameter 40 nm) as a particle containing a silicon atom, and YSZ balls (0.2 mm) were inputted, and they were mixed in a planet ball mill. A solution from which the YSZ balls had been separated by a suction filtration method was filled in an aluminum cup, and was left on a hot plate of 80° C. for 30 minutes, and further on the hot plate of 150° C. for 1 hour, and was dried and solidified. The obtained solidified matter was held and burned in an Ar atmosphere at 1000° C. for five hours. The material after burning was pulverized in an agate mortar, and a negative electrode active material of −45 micrometers was obtained by sieving. Using this negative electrode active material, 50 mass % graphite, 16 mass % polyimide similarly as the binder were added to this, and thereby an electrode was obtained. The electrode similarly manufactured was cut off at 20 mm square, to prepare a sample for a charge/discharge test, and cutting strength evaluation, and a cutting strength measurement was performed to the sample.

### Comparative Example 3

A negative electrode active material was manufactured by the same method as the example 1, except that without performing a pretreatment process, a slurry forming process was performed using silicon fine particles of an average particle diameter of 40 nm, in place of a silicon sintered body. Using this negative electrode active material, 15 mass % graphite, 8 mass % polyimide similarly as the binder were added to this, and thereby an electrode was obtained. The electrode similarly manufactured was cut off at 20 mm square, to prepare a sample for a charge/discharge test, and cutting strength evaluation, and a cutting strength measurement was performed to the sample.

TABLE 2

| | cutting | standard | |
|---|---|---|---|
| | strength kN/m | deviation | cycle life |
| example 1 | 0.696 | 0.084 | 81 |
| example 2 | 1.17 | 0.080 | 95 |
| example 3 | 0.775 | 0.059 | 90 |
| example 4 | 0.710 | 0.064 | 89 |
| example 5 | 0.6 | 0.05 | 80 |
| example 6 | 2.0 | 0.2 | 98 |
| comparative | 0.204 | 0.027 | 45 |
| example 1 | | | |
| comparative | 0.664 | 0.047 | 55 |
| example 2 | | | |
| comparative | 0.940 | 0.041 | 51 |
| example 3 | | | |

Table 2 shows a cycle life regarding a cutting strength and a standard deviation in each of the examples 1 to 6, the comparative examples 1 to 3.

From the above Table, it is found that if an average value of the cutting strength is not less than 0.6 kN/m and not more than 2.0 kN/m, and preferably not less than 0.7 kN/m and not more than 1.2 kN/m, and the standard deviation is not less than 0.05 kN/m and not more than 0.2 kN/m, the cycle life is improved. Further, it has been found that, if a difference between a maximum value and a minimum value of the cutting strength is not less than 0.3 kN/m and not more than 1.0 kN/m, a further desirable nonaqueous electrolyte secondary battery can be provided.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An electrode for a nonaqueous electrolyte secondary battery comprising:
a collector; and
an electrode mixture layer formed on a surface of the collector, comprising an active material having a carbonaceous material and metal or an oxide of the metal dispersed in the carbonaceous material, a conductive agent, and a binding agent;
the electrode mixture layer having an average value of a cutting strength of not less than 0.6 kN/m, and a standard deviation of not less than 0.05 kN/m and not more than 0.2 kN/m, when a region at a prescribed depth from a surface of the electrode mixture layer is cut by a borazon blade with a blade width of 1 mm, in a direction in parallel with the surface, at a rake angle θS of 20 degrees, and a relief angle θN of 10 degrees, and at a horizontal speed of 2 μm/sec.

2. The electrode according to claim 1, wherein:
a difference between a maximum value and a minimum value of the cutting strength at the region of the prescribed depth is not more less 0.3 kN/m and not more than 1.0 kN/m.

3. The electrode according to claim 1, wherein:
an average value of the cutting strength at the region of the prescribed depth is not less than 0.6 kN/m and not more than 2.0 kN/m.

4. The electrode according to claim 1, wherein:
the metal is an element of at least one kind selected from a group consisting of Si, Sn, Al, In, Ga, Pb, Ti, Ni, Mg, W, Mo, and Fe.

5. A nonaqueous electrolyte secondary battery using an electrode, comprising:
the electrode having
a collector, and
an electrode mixture layer formed on a surface of the collector, comprising an active material having a carbonaceous material, and metal or an oxide of the metal dispersed in the carbonaceous material, a conductive agent, and a binding agent,
the electrode mixture layer having an average value of a cutting strength of not less than 0.6 kN/m, and a standard deviation of not less than 0.05 kN/m and not more than 0.2 kN/m, when a region at a prescribed depth from a surface of the electrode mixture layer is cut by a borazon blade with a blade width of 1 mm, in a direction in parallel with the surface, at a rake angle θS of 20 degrees, and a relief angle θN of 10 degrees, and at a horizontal speed of 2 μm/sec.

6. A battery pack using a nonaqueous electrolyte secondary battery, comprising:
the nonaqueous electrolyte secondary battery according to claim 5.

7. The battery pack according to claim 6, further comprising:
a protection circuit; and
a terminal for conduction to an external device.
